(19) United States
(12) Patent Application Publication
(10) Pub. No.: US 2016/0325169 A1
(43) Pub. Date: Nov. 10, 2016

(54) SWING ANALYZING DEVICE, SWING ANALYZING METHOD, SWING ANALYZING SYSTEM, AND STORAGE MEDIUM

(71) Applicant: SEIKO EPSON CORPORATION, Tokyo (JP)

(72) Inventor: Masafumi SATO, Hara-mura (JP)

(73) Assignee: SEIKO EPSON CORPORATION, Tokyo (JP)

(21) Appl. No.: 15/132,714

(22) Filed: Apr. 19, 2016

(30) Foreign Application Priority Data
May 7, 2015 (JP) 2015-094664

(51) Int. Cl. A63B 69/36; A63B 71/06; A63B 24/00; G06K 9/00; G06T 11/20

(52) U.S. Cl. CPC A63B 69/36; G06K 9/00671; G06K 9/00342; G06T 11/203; A63B 24/0006; A63B 71/0619; A63B 2220/833; A63B 2220/16; A63B 2220/40; A63B 2208/0204

(57) ABSTRACT

A swing analyzing device (an information terminal) includes an arithmetic processing circuit that calculates an angle of a hitting surface of an exercise implement during a swing using an output of an inertial sensor and an image processing circuit that generates first image data for displaying the angle in a first coordinate system configured by a first scale and generates second image data for displaying the angle in a second coordinate system configured by a second scale having an interval wider than the interval of the first scale.

### BACKGROUND

1. Technical Field

The present invention relates to a swing analyzing device, a swing analyzing method, a swing analyzing system, and a storage medium.

2. Related Art

For example, as described in JP-A-2015-2911 (Patent Literature 1), there has been proposed a device that analyzes a swing of a golf club or the like using an output of an inertial sensor attached to an exercise implement.

The device presents, to a player, swing analysis information such as a tilt of a head section, a swing track, and the like of a club at impact time. The player visually recognizes the swing analysis information displayed on a display screen of a smartphone or the like, which can be carried during play, and uses the swing analysis information as reference for the next play.

In Patent Literature 1, the device displays, as a graph or an image, information concerning angles such as the tilt of the head section and the direction of the swing track to improve visibility of the player. The player visually recognizes the displayed image and images a corrected swing or the like for the next play.

However, when the angles are very small, it is sometimes difficult to identify a very small amount of change displayed as the graph or the image. In such a situation, the player is likely to have an image of a wrong corrected swing. In particular, in putting of golf, a very small difference in an angle indicating the tilt of the head or the direction of the swing track significantly affects a result of play. Therefore, it is necessary to cause the player to more accurately image a corrected swing than in other swings.

Therefore, there has been a demand for a swing analyzing device that can cause a player to accurately recognize information concerning an angle in a swing analysis to prevent the player from imaging a wrong corrected swing.

### SUMMARY

An advantage of some aspects of the invention is to solve at least a part of the problems, and the invention can be implemented as the following forms or application examples.

### APPLICATION EXAMPLE 1

A swing analyzing device according to this application example includes: a calculator configured to calculate angle information of a hitting surface of an exercise implement in a swing using an output of an inertial sensor; a first image generator configured to generate first image data for displaying the angle information in a first coordinate system configured by a first scale; and a second image generator configured to generate second image data for displaying the angle information in a second coordinate system configured by a second scale having an interval wider than the interval of the first scale.

According to this application example, a plurality of image data having the scales with the different intervals in the first coordinate system and the second coordinate system are generated in order to display an angle of the hitting surface. By displaying the image data, it is possible to cause a player to recognize the angle of the hitting surface at a plurality of viewpoints. That is, in this application example, since an amount of information larger than an amount of single kind of information is generated as common information such as the angle of the hitting surface using a variety of image data, it is considered that information for allowing the player to easily understand a situation of the swing is generated. Therefore, it is possible to easily recognizably inform the player of information concerning an angle in a swing analysis such as an angle of the hitting surface during the swing.

### APPLICATION EXAMPLE 2

In the swing analyzing device according to the application example, it is preferable that the angle information of the hitting surface is a face angle representing a tilt of the hitting surface at impact time with respect to a direction orthogonal to a hitting target direction in plan view from a direction perpendicular to a ground.

According to this application example, it is possible to easily recognizably inform the player of information concerning the face angle at the impact time.

### APPLICATION EXAMPLE 3

In the swing analyzing device according to the application example, it is preferable that the angle information of the hitting surface is a square degree representing a tilt of the hitting surface with respect to a direction orthogonal to a direction of a swing track at impact time in plan view from a direction perpendicular to a ground.

According to this application example, it is possible to easily recognizably inform the player of information concerning the square degree at the impact time.

### APPLICATION EXAMPLE 4

In the swing analyzing device according to the application example, it is preferable that the angle information of the hitting surface is a delta loft angle representing a tilt of the hitting surface at impact time with respect to an imaginary vertical plane perpendicular to a ground.

According to this application example, it is possible to easily recognizably inform the player of information concerning the delta loft angle at the impact time.

### APPLICATION EXAMPLE 5

In the swing analyzing device according to the application example, it is preferable that the angle information of the hitting surface is an attack angle representing a tilt in a direction of a swing track of the hitting surface at impact time with respect to a hitting target direction.

According to this application example, it is possible to easily recognizably inform the player of information concerning the attack angle at the impact time.

### APPLICATION EXAMPLE 6

In the swing analyzing device according to the application example, it is preferable that the second image data is a moving image for expanding the first scale of the first image data to the interval of the second scale.

According to this application example, it is possible to provide the player with an amount of information larger than an amount of two kinds of screen information using the moving image generated between the first scale and the second scale.

### APPLICATION EXAMPLE 7

In the swing analyzing device according to the application example, it is preferable that the swing analyzing device further includes a display controller configured to control display on a display that displays at least one of the first image data and the second image data.

According to this application example, the player can visually recognize image data in the swing analyzing device.

### APPLICATION EXAMPLE 8

In the swing analyzing device according to the application example, it is preferable that the display controller causes the display to switch and display the first image data and the second image data.

According to this application example, since the first image data and the second image data are switched and displayed on the display, it is possible to cause the display to display the respective image data in a wide display region.

### APPLICATION EXAMPLE 9

In the swing analyzing device according to the application example, it is preferable that the display controller causes the display to simultaneously display the first image data and the second image data.

According to this application example, it is possible to compare the first image data and the second image data on the same display screen.

### APPLICATION EXAMPLE 10

A swing analyzing method according to this application example includes: calculating angle information of a hitting surface of an exercise implement in a swing using an output of an inertial sensor; generating first image data for displaying the angle information in a first coordinate system configured by a first scale; and generating second image data for displaying the angle information in a second coordinate system configured by a second scale having an interval wider than the interval of the first scale.

According to this application example, it is possible to observe, with a plurality of image data, common information such as an angle of the hitting surface. Since an amount of information larger than an amount of single kind of information is generated, a player can easily understand a situation of the swing. Therefore, it is possible to easily recognizably inform the player of information concerning an angle in a swing analysis such as an angle of the hitting surface during the swing.

### APPLICATION EXAMPLE 11

A storage medium according to this application example has stored therein a computer program for causing a computer execute: calculating angle information of a hitting surface of an exercise implement in a swing using an output of an inertial sensor; generating first image data for displaying the angle information in a first coordinate system configured by a first scale; and generating second image data for displaying the angle information in a second coordinate system configured by a second scale having an interval wider than the interval of the first scale.

According to this application example, it is possible to observe, with a plurality of image data, common information such as an angle of the hitting surface. Since an amount of information larger than an amount of single kind of information is generated, a player can easily understand a situation of the swing. Therefore, it is possible to easily recognizably inform the player of information concerning an angle in a swing analysis such as an angle of the hitting surface during the swing.

### APPLICATION EXAMPLE 12

A swing analyzing system according to this application example includes: an inertial sensor configured to detect and output a movement of an exercise implement during a swing; and a swing analyzing device including: a calculator configured to calculate angle information of a hitting surface of the exercise implement using an output of the inertial sensor; a first image generator configured to generate first image data for displaying the angle information in a first coordinate system configured by a first scale; and a second image generator configured to generate second image data for displaying the angle information in a second coordinate system configured by a second scale having an interval wider than the interval of the first scale.

According to this application example, it is possible to observe, with a plurality of image data, common information such as an angle of the hitting surface. Since an amount of information larger than an amount of single kind of information is generated, a player can easily understand a situation of the swing. Therefore, it is possible to easily recognizably inform the player of information concerning an angle in a swing analysis such as an angle of the hitting surface during the swing.

### BRIEF DESCRIPTION OF THE DRAWINGS

The invention will be described with reference to the accompanying drawings, wherein like numbers reference like elements.

FIG. 1 is an explanatory diagram showing an overview of a swing analyzing system.

FIG. 2 is a conceptual diagram schematically showing the configuration of the swing analyzing system.

FIG. 3 is a block diagram schematically showing the configuration of an arithmetic processing circuit.

FIGS. 4A and 4B are explanatory diagrams showing face angles and square degrees in a plan view direction.

FIGS. 5A and 5B are explanatory diagrams showing delta loft angles and attack angles in a front view direction.

FIG. 6 is a block diagram schematically showing the configuration of an image processing circuit.

FIG. 7A is a diagram showing a display screen on which the face angle is represented as an actual angle.

FIG. 7B is a diagram showing a display screen on which the face angle is represented as an exaggerated angle.

FIG. 8A is a diagram showing a display screen on which the square degree is represented as an actual angle.

FIG. 8B is a diagram showing a display screen on which the square degree is represented as an exaggerated angle.

FIG. 9A is a diagram showing a display screen on which the delta loft angle is represented as an actual angle.

FIG. 9B is a diagram showing a display screen on which the delta loft angle is represented as an exaggerated angle.

FIG. 10A is a diagram showing a display screen on which the attack angle is represented as an actual angle.

FIG. 10B is a diagram showing a display screen on which the attack angle is represented as an exaggerated angle.

FIG. 11 is a flowchart for explaining a flow of swing analysis processing.

### DESCRIPTION OF EXEMPLARY EMBODIMENTS

Embodiments of the invention are explained below with reference to the drawings. Note that, in the figures referred to below, layers and members are sometimes shown in scales different from actual scales in order to show the layers and the members in recognizable sizes.

### FIRST EMBODIMENT

### Overview of a Swing Analyzing System

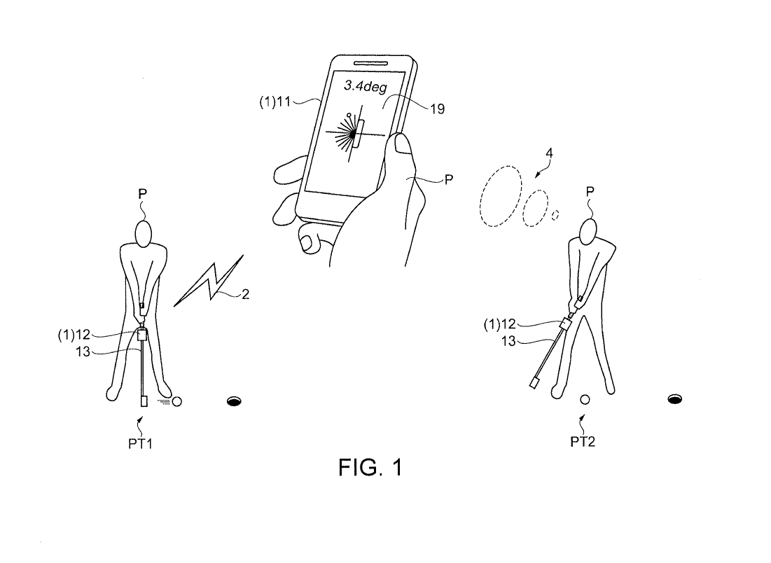

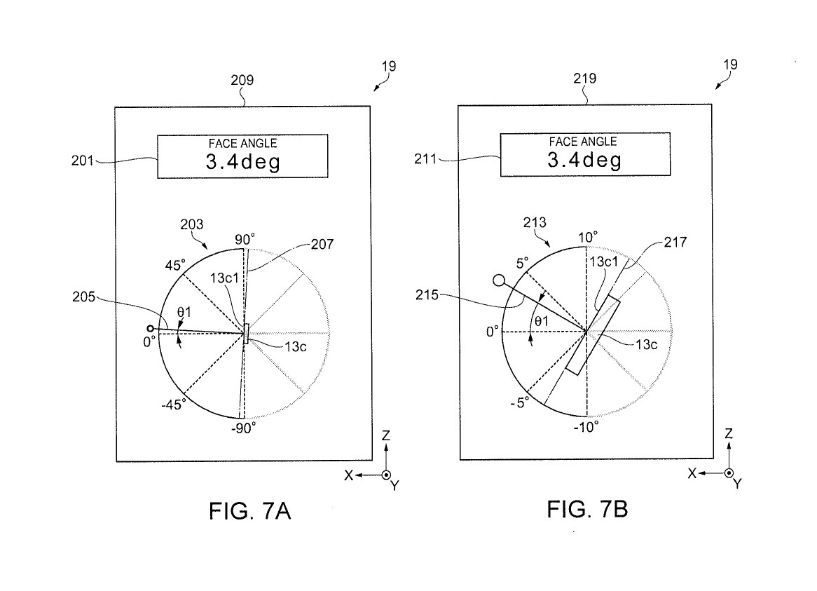

FIG. 1 is an explanatory diagram showing an overview of a swing analyzing system. FIGS. 7A to 10B are diagrams showing display screens. Note that, in this embodiment, a swing analysis of golf is explained as an example. However, the invention can also be applied to sports in which rackets, bats, and the like are used as exercise implements such as tennis, baseball, table tennis, and badminton.

A swing analyzing system 1 in this embodiment includes an information terminal 11 functioning as a swing analyzing device carried by a player P who plays golf and an inertial sensor 12 attached to or incorporated in a golf club 13. The inertial sensor 12 detects a movement or the like involved in a swing of the golf club 13 and outputs a detection signal. The information terminal 11 and the inertial sensor 12 are connected to be capable of communicating a detection signal by communication 2 such as near field radio.

The player P shown in FIG. 1 is playing putting as a golf swing. A putt PT1 represents a state in which the player P is patting. A putt PT2 represents a state in which the same player P is putting under conditions (a distance to a cup, a state of a green, etc.) similar to conditions for the putt PT1 after a time period when the putt PT1 is carried out.

When the putting by the putt PT1 is started, a detection signal detected by the inertial sensor 12 is transmitted to the information terminal 11 via the communication 2. The information terminal 11 calculates a swing track of the golf club 13, an angle of a hitting surface of a head, and the like corresponding to the putt PT1 on the basis of the detection signal and displays swing analysis information of the putt PT1 on a display device 19. The swing analysis information is stored in a storage device 16 (explained below) of the information terminal 11 for each kind of play. The player P checks the swing analysis information and grasps a result of a swing of the player P in the putt PT1.

In the putt PT2, before a start of putting of the putt PT2, swing analysis information at the time of putting under similar conditions by the player P is displayed on the display device 19 of the information terminal 11. The player P visually recognizes the displayed swing analysis information and images a corrected swing. Subsequently, in the putt PT2, the player P recollects the visually recognized swing analysis information and the corrected swing (recollection 4) and starts putting.

The similar conditions of the putting are, for example, conditions such as a distance from an address position to a cup and a state of a green. When those kinds of information are input to the information terminal 11, similar switching analysis information of a most recent swing is displayed. When there are a plurality of kinds of similar information, a plurality of kinds of information may be displayed.

The swing analysis information by the putt PT1 is displayed on the display device 19 of the information terminal 11 as graphical video information as shown in FIGS. 7A to 10B. In FIGS. 7A to 10B, two kinds of video information (A) and (B) are displayed with respect to the same swing analysis information. For example, when the swing analysis information is a very small angle, a display screen (A) corresponding to an actual angle and a display screen (B) corresponding to an exaggerated angle are generated and displayed. Two kinds of image information, that is, image information of the actual angle and image information of the exaggerated angle are performed, whereby the player P compares the very small actual angle and the exaggerated angle as image information in the next putt PT2 and expands an image of a corrected swing. Then, the player P can putt. In this way, it is possible to cause the player P to intuitively and accurately recognize analysis information.

Note that an example is explained in which the player P carries the information terminal 11. However, the information terminal 11 may be used by another person such as a coach who trains the player P or a caddie who assists the player P. In that case, it is possible to cause the other person to intuitively and accurately recognize analysis information. Therefore, the other person can provide the player P with appropriate advice.

### Configuration of the Swing Analyzing System

Such a swing analyzing system 1 is explained in detail below.

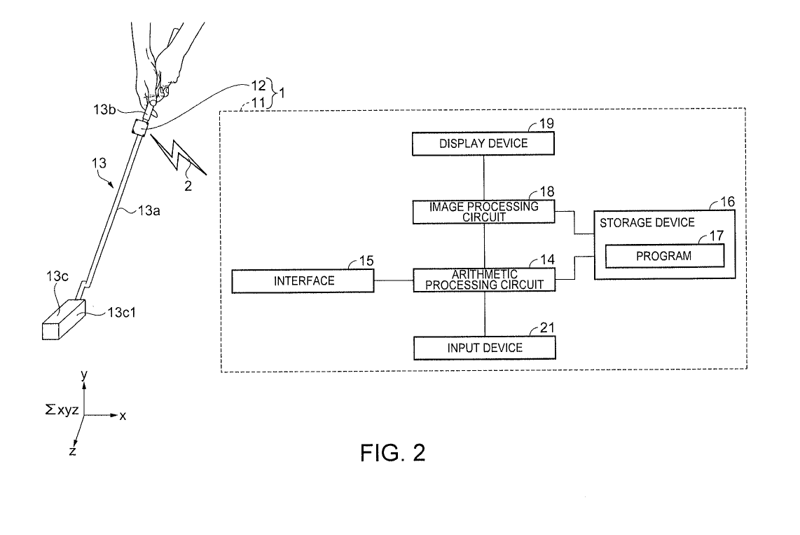

FIG. 2 is a conceptual diagram schematically showing the configuration of the swing analyzing system.

The swing analyzing system 1 includes the inertial sensor 12 and the information terminal 11.

An acceleration sensor and a gyro sensor are built in the inertial sensor 12. The acceleration sensor can detect accelerations respectively in three axial directions orthogonal to one another. The gyro sensor can individually detect angular velocities around three axes (x, y, and z) orthogonal to one another. The inertial sensor 12 outputs a detection signal. Acceleration and angular velocity are specified for each of the axes according to the detection signal. The acceleration sensor and the gyro sensor relatively accurately detect information concerning the acceleration and the angular velocity. The inertial sensor 12 is attached to the golf club 13. The golf club 13 is, for example, a golf putter and includes a shaft 13a and a grip 13b. The grip 13b is gripped by hands. The grip 13b is formed coaxially with the axis of the shaft 13a. A club head 13c is joined to the distal end of the shaft 13a. The inertial sensor 12 is desirably attached to the shaft 13a or the grip 13b of the golf club 13. The inertial sensor 12 only has to be fixed to the golf club 13 to be unable to relatively move. The inertial sensor 12 may be incorporated in the shaft 13a of the golf club 13.

When the inertial sensor 12 is attached, one of the detection axes (the z axis) of the inertial sensor 12 is aligned with the axis of the shaft 13a. Another one of the detection axes of the inertial sensor 12 (the x axis) is aligned with a direction obtained by projecting, on the horizontal plane, a direction (a face normal direction) perpendicular to a face surface 13c1 (a hitting surface) in a state in which a sole (a grounded surface) of the club head 13c is set horizontal. The face surface is not always the vertical plane and inclines with respect to the vertical plane. Therefore, the direction obtained by projecting the face normal direction on the horizontal plane is set as the x axis. The y axis is orthogonal to the x axis and the z axis. A sensor coordinate system Σxyz is defined by the x, y, and z axes.

The information terminal 11 includes an arithmetic processing circuit 14. A predetermined interface 15 is connected to the arithmetic processing circuit 14. The interface 15 receives a detection signal from the inertial sensor 12 via the communication 2 and outputs the detection signal to the arithmetic processing circuit 14. As a preferred example, the interface 15 is a near field radio adapter having a communication protocol common to a communication adapter (not shown in the figure) provided in the inertial sensor 12. The interface 15 only has to be capable of connecting the inertial sensor 12 and the information terminal 11 to be capable of transmitting and receiving signals. For example, the interface 15 may be connected to the inertial sensor 12 by wire.

The storage device 16 is connected to the arithmetic processing circuit 14. The storage device 16 is a storage device such as a ROM (Read Only Memory), a flash ROM, a RAM (Random Access Memory), an HDD (Hard Disk Drive), or an SSD (Solid State Drive). The storage device 16 has stored therein a computer program 17 functioning as a swing analyzing program, data (not shown in the figure) of swing analysis information calculated for each swing, a work area for temporarily storing a processing result and the like, various kinds of setting information such as display control information stored in advance, and the like. The storage device 16 includes, in a RAM region, a drawing region for display such as a VRAM (Video RAM). Screen data to be displayed on the display device 19 is stored to be capable of being edited.

Club specification information representing the specifications of the golf club 13, sensor attachment position information, and the like are also stored in the storage device 16. For example, the player P operates an input device 21 to input a model number of the golf club 13 to be used (or selects the model number from a model number list). Among specification information (information such as the length of the shaft, a face angle, and a loft angle) for each of model numbers stored in advance in the storage device 16, specification information of the input model number is set as the club specification information. Alternatively, assuming that the inertial sensor 12 is attached to a predetermined position (e.g., a distance of 20 cm from the grip), information concerning the predetermined position may be stored in advance as the sensor attachment position information. As exercise conditions, for example, in the case of a golf putter, a distance from an address position to a cup and states of a green such as speed on turf grass are stored in the storage device 16 via the input device 21.

An image processing circuit 18 is connected to the arithmetic processing circuit 14. The arithmetic processing circuit 14 sends swing analysis information obtained by analyzing a swing to the image processing circuit 18. The display device 19 is connected to the image processing circuit 18. In the connection, a predetermined interface circuit (not shown in the figure) is connected to the image processing circuit 18. The image processing circuit 18 generates image data displayed on the basis of the swing analysis information and sends an image signal to the display device 19 according to the image data. An image specified on the basis of the image signal is displayed on the display device 19. Note that processing details of the image processing circuit 18 are explained below.

The arithmetic processing circuit 14 or the image processing circuit 18 can convert a coordinate space of the sensor coordinate system Σxyz into an absolute reference coordinate system ΣXYZ (e.g., an X-Z plane is the horizontal plane and an X-Y plane is the vertical plane), which is a real space (a three-dimensional space).

As the display device 19, electronic paper, an LCD (Liquid Crystal Display), an organic electroluminescence display, another flat panel display, or the like is used. The image is displayed as a three-dimensional image or a two-dimensional image in the absolute reference coordinate system ΣXYZ. The arithmetic processing circuit 14, the storage device 16, and the image processing circuit 18 are provided as, for example, a smartphone or a tablet computer device. Note that the arithmetic processing circuit 14, the storage device 16, and the image processing circuit 18 are equivalent to a computer. The display device 19 is equivalent to a display.

The input device 21 is connected to the arithmetic processing circuit 14. The input device 21 is, for example, a touch panel or a keyboard. At least character information and numerical value information are input to the input device 21. The input character information and the input numerical value information are output to the arithmetic processing circuit 14.

### Overview of the Arithmetic Processing Circuit

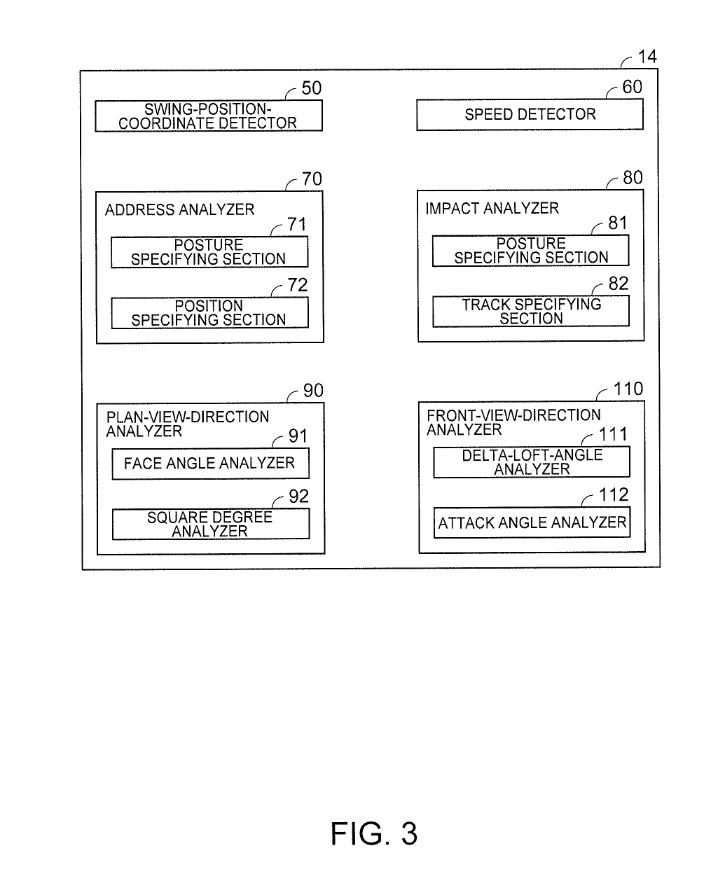

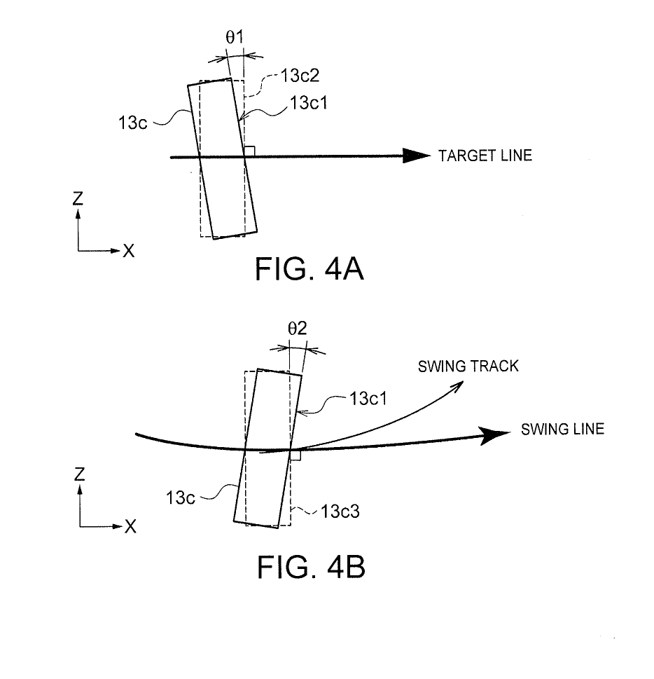

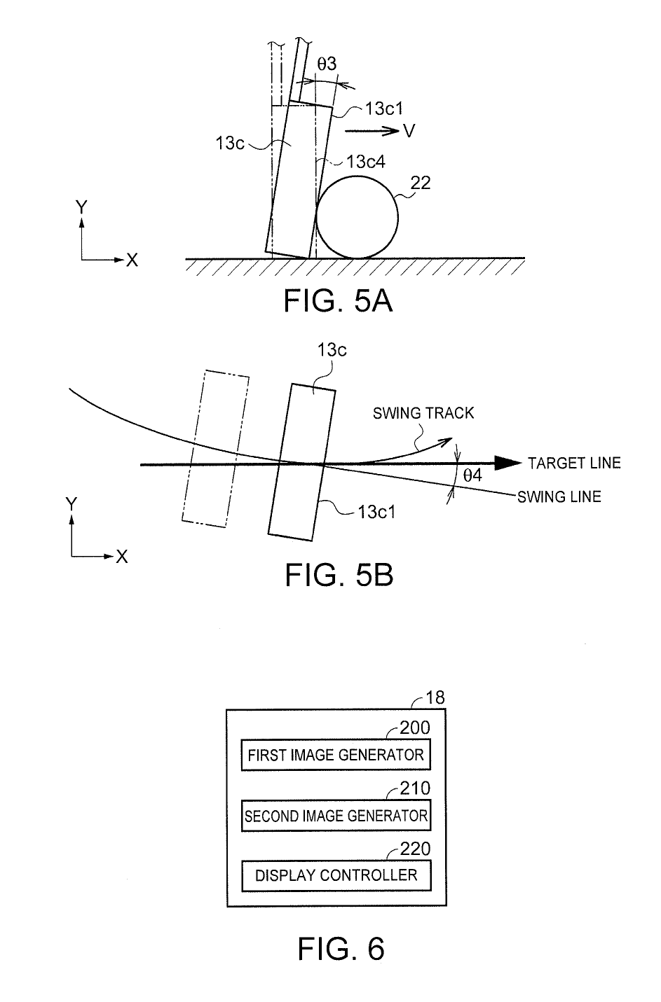

FIG. 3 is a block diagram schematically showing the configuration of the arithmetic processing circuit. FIGS. 4A and 4B are explanatory diagrams showing face angles and square degrees in a plan view direction. FIGS. 5A and 5B are explanatory diagrams showing delta loft angles and attack angles in a front view direction.

Note that a direction (a −Y direction) of view from the vertical direction with respect to the ground is referred to as plan view. A direction (a −Z direction) in which an imaginary vertical surface (an X-Y plane) perpendicular to the ground is viewed with respect to the player P is referred to as front view.

The arithmetic processing circuit 14 includes functional sections such as a swing-position-coordinate detector 50, a speed detector 60, an address analyzer 70, an impact analyzer 80, a plan-view-direction analyzer 90, and a front-view-direction analyzer 110. However, these functional sections are only examples. Not all of the functional sections are always required. The arithmetic processing circuit 14 may include functional sections other than these functional sections.

The swing-position-coordinate detector 50 detects coordinates of the club head 13c during a swing from a swing start position (an address position) to a swing turn position (a top position), a hitting position (an impact imaginary perpendicular plane position), and a swing end position (a finish position).

The speed detector 60 detects, for example, speed V of the club head 13c at impact time using an output from the inertial sensor 12 (see FIG. 5A). The address analyzer 70 includes a posture specifying section 71 and a position specifying section 72. The address analyzer 70 analyzes a posture and a position of the face surface 13c1 of the club head 13c at address time (at standstill time). The impact analyzer 80 includes a posture specifying section 81 and a track specifying section 82. The impact analyzer 80 analyzes a posture of the face surface 13c1 of the club head 13c at the impact time and a track of the face surface 13c1 near the impact.

The plan-view-direction analyzer 90 includes a face angle analyzer 91 and a square degree analyzer 92. The plan-view-direction analyzer 90 analyzes a direction of the club head 13c in plan view and outputs a face angle and a square degree included in the swing analysis information. As shown in FIG. 4A, the plan-view-direction analyzer 90 analyzes an angle formed by the face surface 13c1 at the impact time and an imaginary perpendicular plane 13c2 with respect to a hitting target direction (a target line direction: e.g., a direction obtained by projecting, on the X-Z plane, a normal direction of the face surface 13c1 at the address time) and outputs the angle as a face angle θ1. As shown in FIG. 4B, the plan-view-direction analyzer 90 analyzes an angle formed by the face surface 13c1 at the impact time and an imaginary perpendicular plane 13c3 with respect to a tangential direction (a swing line direction or a ball hitting direction) at the impact time in contact with a moving track (a swing track) of the face surface 13c1 and outputs the angle as a square degree θ2.

The front-view-direction analyzer 110 includes a delta-loft-angle analyzer 111 and an attack angle analyzer 112. The front-view-direction analyzer 110 analyzers a direction of the club head 13c in front view right opposed to the player P and outputs a delta loft angle and an attack angle included in the swing analysis information. As shown in FIG. 5A, the front-view-direction analyzer 110 analyzes an angle formed by an inclination angle (an actual loft angle) with respect to a vertical plane 13c4 of the face surface 13c1 at the impact time and a reference inclination angle (e.g., a loft angle, which is a standard value of the putter; in FIG. 5A, drawn as a substantially vertical surface) and outputs the angle as a delta loft angle θ3. As shown in FIG. 5B, the front-view-direction analyzer 110 analyzes an angle formed by a tangential direction (a swing line direction) at the impact time in contact with a moving track (a swing track) of the face surface 13c1 projected on the vertical plane and a target direction (a target line or a hitting target direction) projected on the vertical plane and outputs the angle as an attack angle θ4.

Note that a method of calculating various kinds of swing analysis information on the basis of an output signal of the inertial sensor 12 realized in the functional sections included in the arithmetic processing circuit 14 is disclosed in Patent Literature 1.

Note that all of the face angle θ1, the square degree θ2, the delta loft angle θ3, and the attack angle θ4 at the impact time are equivalent to angles of the hitting surface. The arithmetic processing circuit 14 is equivalent to the calculator.

### Overview of the Image Processing Circuit

FIG. 6 is a block diagram schematically showing the configuration of the image processing circuit.

The image processing circuit 18 includes functional sections such as a first image generator 200, a second image generator 210, and a display controller 220. However, these functional sections are only examples. Not all of the functional sections are always required. The image processing circuit 18 may include functional sections other than these functional sections.

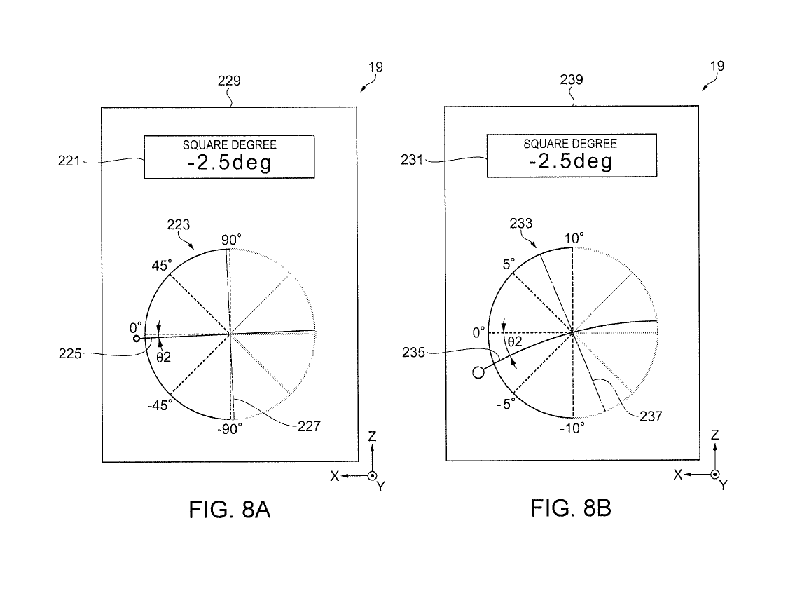

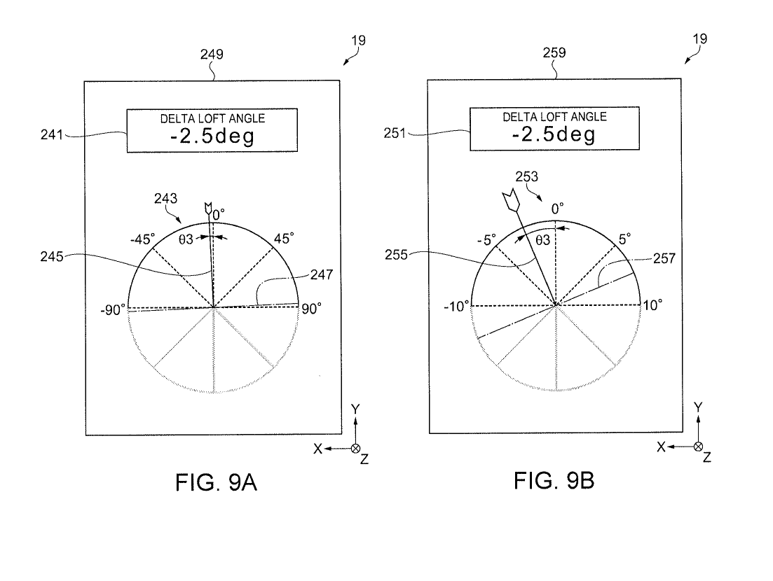

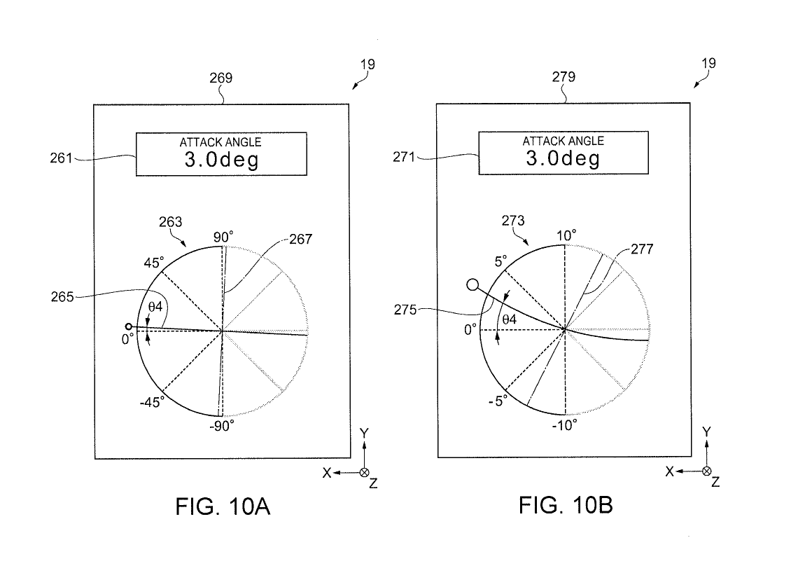

The first image generator 200 generates screen data in which an angle output as swing analysis information is represented as an actual angle (hereinafter referred to as actual angle) on a screen. Specifically, the first image generator 200 draws a scale of a polar coordinate drawn in the drawing region of the storage device 16 at the same angle (interval) as a scale of the actual angle. Specifically, the first image generator 200 has, on the drawn polar coordinate, a 90° axis and a −90° axis crossing perpendicularly to a 0° axis. The first image generator 200 draws, on the drawn polar coordinate, an angle axis of the face angle θ1 included in the swing analysis information acquired from the arithmetic processing circuit 14. Similarly, the first image generator 200 draws the square degree θ2, the delta loft angle θ3, and the attack angle θ4 included in the swing analysis information respectively as angle axes. Data drawn in the drawing region for each of the angles is managed as screen data for each of the angles. Note that screens shown in FIG. 7A, FIG. 8A, FIG. 9A, and FIG. 10A are display examples in which the screen data generated by the first image generator 200 is displayed on the screen of the display device 19.

Note that the screen data generated by the first image generator 200 is equivalent to the first image data. A polar coordinate system of the actual angle is equivalent to the first coordinate system. A scale of the actual angle is equivalent to the first scale.

The second image generator 210 generates screen data in which the angle output as the swing analysis information is represented as an angle represented to be exaggerated larger than the actual angle (hereinafter referred to as exaggerated angle). Specifically, the second image generator 210 defines an exaggerated coordinate system in which a coordinate scale of the polar coordinate system drawn in the drawing region is set to an angle (an interval) wider than a scale of the actual angle. For example, by displaying one degree of the actual angle in nine times width in the exaggerated angle, in the exaggerated coordinate system, the second image generator 210 can draw a polar coordinate including a 10° axis and a −10° axis crossing perpendicularly to the 0° axis. The second image generator 210 draws an angle axis of the face angle θ1 on the drawn polar coordinate of the exaggerated angle. Similarly, the second image generator 210 draws the square degree θ2, the delta loft angle θ3, and the attack angle θ4 included in the swing analysis information respectively as angle axes. Data drawn in the drawing region for each of the angles is managed as screen data for each of the angles. Note that screens shown in FIG. 7B, FIG. 8B, FIG. 9B, and FIG. 10B are display examples in which the screen data generated by the second image generator 210 is displayed on the screen of the display device 19.

Note that the screen data generated by the second image generator 210 is equivalent to the second image data. A polar coordinate system of the exaggerated angle is equivalent to the second coordinate system. A scale of the exaggerated angle is equivalent to the second scale.

The display controller 220 controls display of the screen data generated by the first image generator 200 and the second image generator 210 and outputs the screen data to the display device 19. Specifically, the display controller 220 reads display control information stored in the storage device 16 in advance and performs display control conforming to the display control information. In the display control information, a series of processing procedures for displaying, for each of the angles output as the swing analysis information, the screen data generated by the first image generator 200 and subsequently displaying the screen data generated by the second image generator 210 are described. For example, when the swing analysis information is output from the arithmetic processing circuit 14, in the display controller 220, a series of processing procedures for displaying the display screen shown in FIG. 7A and displaying the display screen shown in FIG. 7B after several seconds may be described. A series of processing procedures for, in a state in which the display screen shown in FIG. 7A is displayed, waiting for a tap of the touch panel of the input device 21, displaying the display screen shown in FIG. 7B when the touch panel is tapped may be described.

Such processing procedures can be freely changed by changing contents of the display control information stored in the storage device 16.

### Display Examples in the Display Device

Displays examples in the display device are explained with reference to FIGS. 7A to 10B. Screen display examples shown in FIGS. 7A to 10B are screens displayed when screen data generated by the image processing circuit 18 is output to the display device 19.

FIGS. 7A and 7B are display screen examples of the face angle θ1 (FIG. 4A). FIG. 7A is a diagram showing a display screen on which the face angle is represented as an actual angle. FIG. 7B is a diagram showing a display screen on which the face angle is represented as an exaggerated angle. FIGS. 8A and 8B are display screen examples of the square degree θ2 (FIG. 4B). FIG. 8A is a diagram showing a display screen on which the square degree is represented as an actual angle. FIG. 8B is a diagram showing a display screen on which the square degree is represented as an exaggerated angle. FIGS. 9A and 9B are display screen examples of the delta loft angle θ3 (FIG. 5A). FIG. 9A is a diagram showing a display screen on which the delta loft angle is represented as an actual angle. FIG. 9B is a diagram showing a display screen on which the delta loft angle is represented as an exaggerated angle. FIGS. 10A and 10B are screen display examples of the attack angle θ4 (FIG. 5B). FIG. 10A is a diagram showing a display screen on which the attack angle is represented as an actual angle. FIG. 10B is a diagram showing a display screen on which the attack angle is represented as an exaggerated angle.

Note that the screens shown in FIGS. 7A to 10B are screens showing a state in which the player P is set at a visual point and a visual line of the player P is directed to the head 13c side of the golf club 13. By displaying a screen with the player P set at the visual point, the player P can easily image a corrected swing of the player P based on a visually recognized state.

Coordinates in FIGS. 7A to 10B are represented by the reference coordinate system ΣXYZ. Directions of the X axis, the Y axis, and the Z axis are described in the figures.

The display screen examples shown in FIGS. 7A and 7B are explained.

A screen 209 shown in FIG. 7A includes display regions of a title region 201 and a polar coordinate region 203.

The title region 201 is a region where angle is displayed as a numerical value. A “face angle” and “3.4 deg” are displayed. The title region 201 indicates that the face angle is 3.4°.

A polar coordinate region 203 is a region where a polar coordinate and a face angle are displayed. The face angle is displayed on the screen as an actual angle. Therefore, the 0° axis and the 90° axis are orthogonally disposed. Specifically, the 0° axis, the 90° axis and the −90° axis orthogonal to the 0° axis, a 45° axis in the middle of the 0° axis and the 90° axis, and a −45° axis in the middle of the 0° axis and the −90° axis are disposed. The head 13c including the face surface 13c1 is disposed in the center of the polar coordinate region 203.

An angle axis 205 is an axis representing the face angle as the actual angle. The angle axis 205 extends from the center of the polar coordinate. A circular design for giving an image of a golf ball is disposed at the distal end of the angle axis 205. The angle axis 205 is disposed between the 0° axis and the 45° axis in a position where 3.4° from the 0° axis is represented as an actual angle on the screen as well.

An angle Dθx formed by such an angle axis on the screen is calculated by Expression 1 below.

Dθx=Rθx×(Dθy/Rθy) (Expression 1)

Dθx an angle formed by the angle axis on the screen

Rθx an actual angle of the angle axis

Dθy an angle formed by the coordinate axis on the screen

Rθy an actual angle of the coordinate axis (an angle written on the coordinate axis)

In the polar coordinate region 203, Rθx is 3.4°, Rθy is 45°, for example, when the 45° axis is set as a target, and Dθy is 45° because the 45° axis forms 45° on the screen as well. Dθx is calculated as 3.4° from 3.4°×45°/45°.

In this way, the angle axis 205 representing the face angle θ1 (3.4°) as an actual angle is displayed in a position of 3.4° on the screen as well.

A perpendicular axis 207 represents an axis perpendicular to the angle axis 205.

A screen 219 shown in FIG. 7B includes display regions of a title region 211 and a polar coordinate region 213.

The title region 211 indicates that the face angle is 3.4°.

The polar coordinate region 213 is a region where an exaggerated angle of the face angle and a polar coordinate for the exaggerated angle are displayed. In order to display the exaggerated angle, as coordinate axes, the 0° axis, the 10° axis and the −10° axis orthogonal to the 0° axis, a 5° axis in the middle of the 0° axis and the 10° axis, and a −5° axis in the middle of the 0° axis and the −10° axis are disposed. The head 13c and the face surface 13c1 are displayed in the center of the polar coordinate region 213 in size larger than the head 13c shown in FIG. 7A.

An angle axis 215 is an axis representing the face angle as an exaggerated angle and extends from the center of the polar coordinate. A design for giving an image of a golf ball larger than that shown in FIG. 7A is disposed at the distal end of the angle axis 215.

The angle axis 215 is disposed between the 0° axis and the 5° axis in a position of an angle 30.6° on the screen. An angle on the screen of the angle axis 215 is calculated using the above Expression 1. Specifically, Rθx is 3.4°, Rθy is 5°, for example, when the 5° axis is set as a target, and Dθy is 45° because the 5° axis forms 45° on the screen. Dθx is calculated as 30.6° from 3.4°×45°/5°.

In this way, the angle axis 215 representing the face angle θ1 (3.4°) as an exaggerated angle is displayed in a position of 30.6° on the screen.

A perpendicular axis 217 represents an axis perpendicular to the angle axis 215.

The display screen examples shown in FIGS. 8A and 8B are explained.

A screen 229 shown in FIG. 8A includes display regions of a title region 221 and a polar coordinate region 223.

The title region 221 is a region where an angle is displayed as a numerical value. A “square degree” and “−2.5 deg” are displayed. The title region 221 indicates that the square degree is −2.5°.

The polar coordinate region 223 is a region where a polar coordinate and a square degree are displayed. The square degree is displayed on the screen as an actual angle. Therefore, the 0° axis and the 90° axis are orthogonally disposed. Specifically, the 0° axis, the 90° axis and the −90° axis orthogonal to the 0° axis, the 45° axis in the middle of the 0° axis and the 90° axis, and the −45° axis in the middle of the 0° axis and the −90° axis are disposed.

An angle axis 225 is an axis representing the square degree as an actual angle. A circular design for giving an image of a golf ball is disposed at the distal end of the angle axis 225 extending from the center of the polar coordinate. The angle axis 225 is disposed between the 0° axis and the −45° axis in a position where −2.5° from the 0° axis is represented as an actual angle on the screen as well. An angle on the screen of the angle axis 225 is calculated using the above Expression 1. Specifically, Rθx is −2.5°, Rθy is −45°, for example, when the −45° axis is set as a target, and Dθy is −45° because the −45° axis forms −45° on the screen as well. Dθx is calculated as −2.5° from −2.5°×−45°/−45°. In this way, the angle axis 225 representing the square degree θ2 (−2.5°) as an actual angle is displayed in a position of −2.5° on the screen.

A perpendicular axis 227 represents an axis perpendicular to the angle axis 225.

A screen 239 shown in FIG. 8B includes display regions of a title region 231 and a polar coordinate region 233.

The title region 231 indicates that the square degree is −2.5°.

The polar coordinate region 233 is a region where an exaggerated angle of the square degree and a polar coordinate for the exaggerated angle are displayed. In order to display the exaggerated angle, as coordinate axes, the 0° axis, the 10° axis and the −10° axis orthogonal to the 0° axis, the 5° axis in the middle of the 0° axis and the 10° axis, and the −5° axis in the middle of the 0° axis and the −10° axis are disposed.

An angle axis 235 is an axis representing the square degree as an exaggerated angle and passes the center of the polar coordinate. A design for giving an image of a golf ball larger than that shown in FIG. 8A is disposed at the distal end of the angle axis 235.

The angle axis 235 is disposed between the 0° axis and the −5° axis in a position of an angle −22.5° on the screen. An angle on the screen of the angle axis 235 is calculated using the above Expression 1. Specifically, Rθx is −2.5°, Rθy is −5°, for example, when the −5° axis is set as a target, and Dθy is −45° because the −5° axis forms −45° on the screen. Dθx is calculated as −22.5° from −2.5°×−45°/−5°.

In this way, the angle axis 235 representing the square degree θ2 (−2.5°) as an exaggerated angle is displayed in a position of −22.5° on the screen.

A perpendicular axis 237 represents an axis perpendicular to the angle axis 235.

The display screen examples shown in FIGS. 9A and 9B are explained.

A screen 249 shown in FIG. 9A includes display regions of a title region 241 and a polar coordinate region 243.

The title region 241 is a region where an angle is displayed as a numerical value. A “delta loft angle” and “−2.5 deg” are displayed. The title region 241 indicates that the delta loft angle is −2.5°.

The polar coordinate region 243 is a region where a polar coordinate and a delta loft angle are displayed. The delta loft angle is displayed on the screen as an actual angle. Therefore, the 0° axis and the 90° axis are orthogonally disposed. Specifically, the 0° axis, the 90° axis and the −90° axis orthogonal to the 0° axis, the 45° axis in the middle of the 0° axis and the 90° axis, and the −45° axis in the middle of the 0° axis and the −90° axis are disposed.

An angle axis 245 is an axis representing the delta loft angle as an actual angle. A design for giving an image of the grip 13b is disposed at the distal end of the angle axis 245 extending from the center of the polar coordinate. The angle axis 245 is disposed between the 0° axis and the −45° axis in a position where −2.5° from the 0° axis is represented as an actual angle on the screen as well. An angle on the screen of the angle axis 245 is calculated using the above Expression 1. Specifically, Rθx is −2.5°, Rθy is −45°, for example, when the −45° axis is set as a target, and Dθy is −45° because the −45° axis forms −45° on the screen as well. Dθx is calculated as −2.5° from −2.5°×−45°/−45°. In this way, the angle axis 245 representing the delta loft angle θ3 (−2.5°) as an actual angle is displayed in a position of −2.5° on the screen as well.

A perpendicular axis 247 represents an axis perpendicular to the angle axis 245.

A screen 259 shown in FIG. 9B includes display regions of a title region 251 and a polar coordinate region 253.

The title region 251 indicates that the delta loft angle is −2.5°.

The polar coordinate region 253 is a region where an exaggerated angle of the delta loft angle and a polar coordinate for the exaggerated angle are displayed. In order to display the exaggerated angle, as coordinate axes, the 0° axis, the 10° axis and the −10° axis orthogonal to the 0° axis, the 5° axis in the middle of the 0° axis and the 10° axis, and the −5° axis in the middle of the 0° axis and the −10° axis are disposed.

An angle axis 255 is an axis representing the delta loft angle as an exaggerated angle and passes the center of the polar coordinate. A design for giving an image of the grip 13b larger than that shown in FIG. 9A is disposed at the distal end of the angle axis 255.

The angle axis 255 is disposed between the 0° axis and the −5° axis in a position of an angle −22.5° on the screen. An angle on the screen of the angle axis 255 is calculated using the above Expression 1. Specifically, Rθx is −2.5°, Rθy is −5°, for example, when the −5° axis is set as a target, and Dθy is −45° because the −5° axis forms −45° on the screen. Dθx is calculated as −22.5° from −2.5°×−45°/−5°.

In this way, the angle axis 255 representing the delta loft angle θ3 (−2.5°) as an exaggerated angle is displayed in a position of −22.5° on the screen.

A perpendicular axis 257 represents an axis perpendicular to the angle axis 255.

The display screen examples shown in FIGS. 10A and 10B are explained.

A screen 269 shown in FIG. 10A includes display regions of a title region 261 and a polar coordinate region 263.

The title region 261 is a region where an angle is displayed as a numerical value. An “attack angle” and “3.0 deg” are displayed. The title region 261 indicates that the attack angle is 3.0°.

The polar coordinate region 263 is a region where a polar coordinate and an attack angle are displayed. The attack angle is displayed on the screen as an actual angle. Therefore, the 0° axis and the 90° axis are orthogonally disposed. Specifically, the 0° axis, the 90° axis and the −90° axis orthogonal to the 0° axis, the 45° axis in the middle of the 0° axis and the 90° axis, and the −45° axis in the middle of the 0° axis and the −90° axis are disposed.

An angle axis 265 is an axis representing the attack angle as an actual angle. A circular design for giving an image of a golf ball is disposed at the distal end of the angle axis 265 extending from the center of the polar coordinate. The angle axis 265 is disposed between the 0° axis and the 45° axis in a position where 3.0° from the 0° axis is represented as an actual angle on the screen as well. An angle on the screen of the angle axis 265 is calculated using the above Expression 1. Specifically, Rθx is 3.0°, Rθy is 45°, for example, when the 45° axis is set as a target, and Dθy is 45° because the 45° axis forms 45° on the screen as well. Dθx is calculated as 3.0° from 3.0°×45°/45°. In this way, the angle axis 265 representing the attack angle θ4 (3.0°) as an actual angle is displayed in a position of 3.0° on the screen as well.

A perpendicular axis 267 represents an axis perpendicular to the angle axis 265.

A screen 279 shown in FIG. 10B includes display regions of a title region 271 and a polar coordinate region 273.

The title region 271 indicates that the attack angle is 3.0°.

The polar coordinate region 273 is a region where an exaggerated angle of the attack angle and a polar coordinate for the exaggerated angle are displayed. In order to display the exaggerated angle, as coordinate axes, the 0° axis, the 10° axis and the −10° axis orthogonal to the 0° axis, the 5° axis in the middle of the 0° axis and the 10° axis, and the −5° axis in the middle of the 0° axis and the −10° axis are disposed.

An angle axis 275 is an axis representing the attack angle as an exaggerated angle and passes the center of the polar coordinate. A design for giving an image of a golf ball larger than that shown in FIG. 10A is disposed at the distal end of the angle axis 275.

The angle axis 275 is disposed between the 0° axis and the 5° axis in a position of an angle 27° on the screen. An angle on the screen of the angle axis 275 is calculated using the above Expression 1. Specifically, Rθx is 3.0°, Rθy is 5°, for example, when the 5° axis is set as a target, and Dθy is 45° because the 5° axis forms 45° on the screen. Dθx is calculated as 27° from 3.0°×45°/5°.

In this way, the angle axis 275 representing the attack angle θ4 (3.0°) as an exaggerated angle is displayed in a position of 27° on the screen.

A perpendicular axis 277 represents an axis perpendicular to the angle axis 275.

### Flow of a Swing Analyzing Method

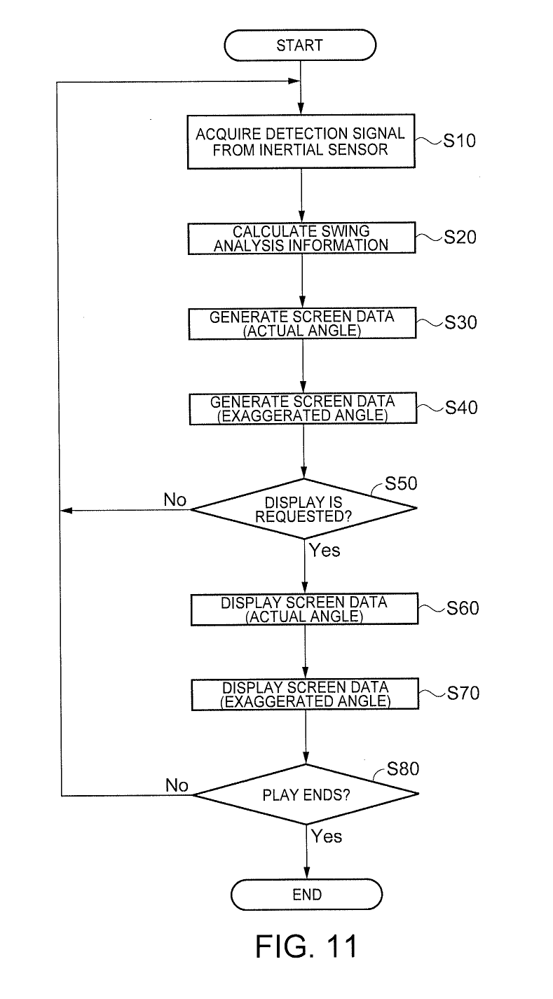

FIG. 11 is a flowchart for explaining a flow of swing analysis processing.

A flow shown in FIG. 11 is a flow of processing realized when the computer program 17 is read in and executed by the arithmetic processing circuit 14 and the image processing circuit 18. This processing is started in a state in which the inertial sensor 12 attached to the golf club 13 detects angular velocity. Note that this flow is equivalent to the swing analyzing method.

In step S10, the arithmetic processing circuit 14 acquires a detection signal from the inertial sensor. The arithmetic processing circuit 14 calculates angular velocities around the x, y, and z axes from the detection signal.

In step S20, the arithmetic processing circuit 14 calculates swing analysis information. The arithmetic processing circuit 14 calculates the face angle θ1, the square degree θ2, the delta loft angle θ3, and the attack angle θ4, which are swing analysis information, from the angular velocities around the axes.

In step S30, the image processing circuit 18 generates screen data of an actual angle. The image processing circuit 18 generates screen data in which the face angle θ1, the square degree θ2, the delta loft angle θ3, and the attack angle θ4 of the swing analysis information are represented as actual angles.

In step S40, the image processing circuit 18 generates screen data of an exaggerated angle. The image processing circuit 18 generates screen data in which the face angle θ1, the square degree θ2, the delta loft angle θ3, and the attack angle θ4 of the swing analysis information are represented as exaggerated angles.

In step S50, the arithmetic processing circuit 14 determines whether a display request is received. The arithmetic processing circuit 14 determines whether a display request for the swing analysis information is input from the input device 21. If the display request is input (Yes), the arithmetic processing circuit 14 proceeds to step S60. If the display request is not input (No), the arithmetic processing circuit 14 proceeds to step S10 in order to acquire the next detection signal.

In step S60, the image processing circuit 18 displays the screen data of the actual angle. The image processing circuit 18 outputs the generated screen data of the actual angle to the display device 19.

In step S70, the image processing circuit 18 displays the screen data of the exaggerated angle. The image processing circuit 18 outputs the generated screen data of the exaggerated angle to the display device 19.

In step S80, the arithmetic processing circuit 14 determines whether play ends. The arithmetic processing circuit 14 determines whether an end request for the swing analysis processing is input from the input device 21. If the end request is input (Yes), the arithmetic processing circuit 14 ends the swing analysis processing. If the end request is not input (No), the arithmetic processing circuit 14 proceeds to step S10 in order to acquire the next detection signal.

As explained above, with the swing analyzing system 1 according to this embodiment, effects explained below can be obtained.

The swing analyzing system 1 calculates swing analysis information on the basis of a detection signal detected in the inertial sensor 12 attached to the exercise implement (the arithmetic processing circuit 14). The swing analysis information includes a face angle, a square degree, a delta loft angle, and an attack angle at impact time. As the swing analysis information, screen data of an actual angle (the first image generator) and screen data of an exaggerated angle (the second image generator) are generated by the image processing circuit 18 for each of kinds of angle information. The generated two kinds of screen data are output to the display device 19 and displayed. The player P checks an actual angle in the displayed screen data of the actual angle and further checks an exaggerated angle in the screen data of the exaggerated angle. By multilaterally checking the angles of the swing analysis information, the player P can intensely recognize information concerning the angles and image a corrected swing in the next play. Therefore, it is possible to easily recognizably inform the player P of information concerning an angle in a swing analysis such as an angle of the hitting surface during a swing.

The invention is not limited to the embodiments explained above. Various changes, improvements, and the like can be applied to the embodiments. Modifications are explained below.

### Modification 1

In the embodiments, the example is explained in which the player P carries the information terminal 11. However, a user of the information terminal 11 is not limited to the player P. The information terminal 11 may be used by another person. In such a form of use, the swing analysis information displayed on the display device 19 is visually recognized by the other person. By visually recognizing the displayed screen data of the actual angle and the displayed screen data of the exaggerated angle, the other person can accurately grasp a situation of a swing and give appropriate advice related to a corrected swing.

### Modification 2

The information terminal 11 according to the embodiments and the modification explained above may be a general-purpose information processing terminal such as a smartphone, a tablet terminal, an HMD (Head Mounted Display), and a notebook PC (Personal Computer). Such an information processing terminal also includes the computer program 17. The computer program 17 is executed by the arithmetic processing circuit 14 and the image processing circuit 18, whereby the functions of the functional sections included in the arithmetic processing circuit 14 and the image processing circuit 18 are executed.

### Modification 3

In the embodiments and the modifications explained above, the information terminal 11 is explained as the portable device. However, the information terminal 11 is not limited to the portable device and may be a desktop PC. The display device 19 may be a projector device that projects an image on a large screen.

Such a modification is suitable for an indoor training facility and the like. The player P and the other person can perform a corrected swing while looking at the large screen.

### Modification 4

The display device 19 described in the embodiments and the modifications explained above may be a general video device that displays a broadcast video. With such a configuration, the analyzed swing analysis information, the actual angle, and the exaggerated angle can be displayed over a video of play of the player P. Consequently, it is possible to plainly communicate a situation of a swing to general people who are viewing a video.

### Modification 5

In the embodiments explained above, as the types of the swing analysis information, the face angle, the square degree, the delta loft angle, and the attack angle are explained as the examples. However, the swing analysis information is not limited to these kinds of analysis information. The invention is also applicable to other analysis information as long as the other analysis information is information calculated as the swing analysis information. For example, the invention can also be applied to a rotation angle of a shaft at the time when the player P takes a square posture, a swing angle corresponding to a V zone indicating an ideal swing track, the respective angles explained above during a practice swing.

### Modification 6

The second image generator 210 according to the embodiments and the modifications generates the screen data represented by the exaggerated angle. However, the screen data is not limited to a still image and may be moving image data. The generated moving image data is desirably moving image data representing a progress in which the screen data represented by the actual angle generated by the first image generator 200 is shifted to the screen data represented by the exaggerated angle stepwise. With such moving image data, since stages of the shift from the actual angle to the exaggerated angle are represented, it is possible to further impress the player P, who visually recognizes the moving image data, with images of the actual angle and the exaggerated angle.

### Modification 7

In the embodiments and the modifications explained above, the example is explained in which the display controller 220 switches and displays the screen data of the actual angle and the screen data of the exaggerated angle. However, the invention is not limited to such control. The same effects can be obtained by any method as long as both the screen data are displayed. For example, the screen data of the actual angle may be switched to the screen data of the exaggerated angle stepwise by a moving image. The screen data of the actual angle and the screen data of the exaggerated angle may be displayed side by side on one display screen. Such control is adaptable by changing the processing procedures described in the computer program 17 executed by the display controller 220.

The entire disclosure of Japanese Patent Application No. 2015-094664, filed May 7, 2015 is expressly incorporated by reference herein.

What is claimed is:

1. A swing analyzing device comprising:
a calculator configured to calculate angle information of a hitting surface of an exercise implement in a swing using an output of an inertial sensor;
a first image generator configured to generate first image data for displaying the angle information in a first coordinate system configured by a first scale; and
a second image generator configured to generate second image data for displaying the angle information in a second coordinate system configured by a second scale having an interval wider than the interval of the first scale.

2. The swing analyzing device according to claim 1, wherein the angle information includes at least one of a face angle representing a tilt of the hitting surface at impact time with respect to a direction orthogonal to a hitting target direction in plan view from a direction perpendicular to a ground, a square degree representing a tilt of the hitting surface with respect to a direction orthogonal to a direction of a swing track at the impact time in plan view from the direction perpendicular to the ground, a delta loft angle representing a tilt of the hitting surface at the impact time with respect to an imaginary vertical plane perpendicular to the ground, and an attack angle representing a tilt in a direction of a swing track of the hitting surface at impact time with respect to a hitting target direction.

3. The swing analyzing device according to claim 1, wherein the second image data is a moving image for expanding the first scale of the first image data to the interval of the second scale.

4. The swing analyzing device according to claim 1, further comprising a display controller configured to control display on a display that displays at least one of the first image data and the second image data.

5. The swing analyzing device according to claim 4, wherein the display controller causes the display to switch and display the first image data and the second image data.

6. The swing analyzing device according to claim 4, wherein the display controller causes the display to simultaneously display the first image data and the second image data.

7. A swing analyzing method comprising:
calculating angle information of a hitting surface of an exercise implement in a swing using an output of an inertial sensor;
generating first image data for displaying the angle information in a first coordinate system configured by a first scale; and
generating second image data for displaying the angle information in a second coordinate system configured by a second scale having an interval wider than the interval of the first scale.

8. The swing analyzing method according to claim 7, wherein the angle information includes at least one of a face angle representing a tilt of the hitting surface at impact time with respect to a direction orthogonal to a hitting target direction in plan view from a direction perpendicular to a ground, a square degree representing a tilt of the hitting surface with respect to a direction orthogonal to a direction of a swing track at the impact time in plan view from the direction perpendicular to the ground, a delta loft angle representing a tilt of the hitting surface at the impact time with respect to an imaginary vertical plane perpendicular to the ground, and an attack angle representing a tilt in a direction of a swing track of the hitting surface at impact time with respect to a hitting target direction.

9. The swing analyzing method according to claim 7, wherein the second image data is a moving image for expanding the first scale of the first image data to the interval of the second scale.

10. The swing analyzing method according to claim 7, further comprising controlling display on a display that displays at least one of the first image data and the second image data.

11. The swing analyzing method according to claim 10, further comprising causing the display to switch and display the first image data and the second image data.

12. The swing analyzing method according to claim 10, further comprising causing the display to simultaneously display the first image data and the second image data.

13. A swing analyzing system comprising:
the swing analyzing device according to claim 1; and
an inertial sensor.

14. A swing analyzing system comprising:
the swing analyzing device according to claim 2; and
an inertial sensor.

15. A storage medium having stored therein a computer program for causing a computer execute:
calculating angle information of a hitting surface of an exercise implement in a swing using an output of an inertial sensor;
generating first image data for displaying the angle information in a first coordinate system configured by a first scale; and
generating second image data for displaying the angle information in a second coordinate system configured by a second scale having an interval wider than the interval of the first scale.

16. A swing analyzing device that generates angle information of a hitting surface of an exercise implement in a swing using an output of an inertial sensor, generates first image data for displaying the angle information in a first coordinate system configured by a first scale, and generates second image data for displaying the angle information in a second coordinate system configured by a second scale having an interval wider than the interval of the first scale.

17. The swing analyzing device according to claim 16, wherein the angle information includes at least one of a face angle representing a tilt of the hitting surface at impact time with respect to a direction orthogonal to a hitting target direction in plan view from a direction perpendicular to a ground, a square degree representing a tilt of the hitting surface with respect to a direction orthogonal to a direction of a swing track at the impact time in plan view from the direction perpendicular to the ground, a delta loft angle representing a tilt of the hitting surface at the impact time with respect to an imaginary vertical plane perpendicular to the ground, and an attack angle representing a tilt in a direction of a swing track of the hitting surface at impact time with respect to a hitting target direction.

18. The swing analyzing device according to claim 16, wherein the swing analyzing device displays at least one of the first coordinate system and the second coordinate system.

19. The swing analyzing device according to claim 18, wherein the swing analyzing device switches and displays the first coordinate system and the second coordinate system.

20. The swing analyzing device according to claim 18, wherein the swing analyzing device simultaneously displays the first coordinate system and the second coordinate system.
